(19) United States
(12) Patent Application Publication
(10) Pub. No.: US 2017/0212974 A1
(43) Pub. Date: Jul. 27, 2017

(54) METHOD FOR SIMULATING A VEHICLE DRIVING THROUGH WATER

(71) Applicant: JAGUAR LAND ROVER LIMITED, Whitley, Coventry, Warwickshire (GB)

(72) Inventor: Prashant KHAPANE, Coventry, Warwickshire (GB)

(21) Appl. No.: 15/129,908

(22) PCT Filed: Mar. 31, 2015
(86) PCT No.: PCT/EP2015/057058

§ 371 Date: Sep. 28, 2016

(30) Foreign Application Priority Data
Mar. 31, 2014 (GB) 1405761.6

(51) Int. Cl. G06F 17/50

(52) U.S. Cl. CPC G06F 17/5018; G06F 17/5095

(57) ABSTRACT

A method of performing a computer implemented analysis of a vehicle in a simulated wading event, the method comprising: defining a trough domain representing a region comprising a water level to be waded by the vehicle; defining a vehicle domain comprising a simulation of the vehicle; the method further comprising: generating a first mesh comprising a plurality of finite mesh elements representing the trough domain; generating a second mesh comprising a plurality of finite mesh elements representing the vehicle domain; defining an overset between the first and second meshes; simulating the wading event by moving the second mesh representing the vehicle domain through the first mesh representing the trough domain, resolving the forces on at least a subset of the finite mesh elements to obtain transient pressures on at least a part of said vehicle domain, and outputting data indicative of said transient pressures

### TECHNICAL FIELD

The present invention relates to a wading simulation method. In particular, the present method relates to the simulation of a vehicle/vehicle components when the vehicle is travelling through different water depths at varying speeds. The invention extends to a method of testing vehicle functional part integrity using the wading simulation method.

### BACKGROUND

Vehicle wading may occur when a vehicle encounters a body of water. Water levels during wading may be low and comprise a splash effect where water hits the underside of the vehicle and drag force/water pressure on the under body of the vehicle are due to air and water combined. Wading may also occur with higher water levels in which the lower part of the vehicle may be submerged in water and the under parts of the vehicle may experience hydrodynamic force and drag.

Vehicle water wading capability refers to vehicle functional part integrity (e.g. engine under-tray, bumper cover, plastic sill cover etc.) when travelling through water. Wade testing involves a vehicle, comprising a function part for testing, being driven through different depths of water at various speeds. The wade test may be repeated with a variety of different function part designs and these functional parts may be inspected afterwards for damage. Wade testing is of particular use in testing under-body function parts.

Traditionally wade testing has involved the physical manufacture of function part designs which are then tested in a wading test. Such a testing process can lead to the late detection of failure modes which inevitably leads to expensive design change, and potentially affects program timing.

The present invention has been devised to mitigate or overcome at least some of the above-mentioned problems.

### SUMMARY OF THE INVENTION

According a first aspect of the present invention there is provided a method of performing a computer implemented analysis of a vehicle in a simulated wading event, the method comprising: defining a trough domain representing a region comprising a water level to be waded by the vehicle; defining a vehicle domain comprising a simulation of the vehicle; the method further comprising: generating a first mesh comprising a plurality of finite mesh elements representing the trough domain; generating a second mesh comprising a plurality of finite mesh elements representing the vehicle domain; defining an overset between the first and second meshes; simulating the wading event by moving the second mesh representing the vehicle domain through the first mesh representing the trough domain, resolving the forces on at least a subset of the finite mesh elements to obtain transient pressures on at least a part of said vehicle domain, and outputting data indicative of said transient pressures.

The present invention provides a method of simulating a vehicle as it encounters a wading event. The vehicle is modeled in a non-classical manner in which the model moves the vehicle through the trough domain (and therefore through the water within the trough) rather than modeling a static vehicle and moving water (classical model). Non-classical modeling provides a more accurate simulation of the pressure field experienced by a wading vehicle in comparison with a classical model and in turn enables failure modes and splash patterns at different wading speeds and water depths to be investigated.

Conveniently, the step of defining the overset mesh may comprise determining an overlap region between the first and second meshes and cutting the overlap region out from the first mesh.

Simulating the wading event may comprise stepping the second mesh through the first mesh in time periods, and wherein for each time period, the overlap region is determined and cut out from the first mesh to define fringe cells in the cut overlap region. The method may comprise coupling outer cells of the second mesh to the fringe cells of the first mesh. Coupling of the first and second meshes may comprise using an interpolation function.

Further meshes may be generated for each functional part of the vehicle.

The vehicle domain may define a functional part of the vehicle and the method may comprise defining a prism layer between the functional part of the vehicle in the vehicle domain and the first mesh representing the trough domain. The boundary layer within the prism region may be resolved.

A first mesh refinement region corresponding to a region of the first mesh representing the trough domain through which the first mesh representing the vehicle domain is to be moved may be created.

A second mesh refinement region corresponding to region surrounding coolpacks may be created.

A third refinement region corresponding to the water within the trough domain may be created.

Simulating the wading event may comprise resolving flow field around the second mesh representing the vehicle domain. Simulating the wading event may comprise solving multiphase flow using a volume of fluid model. Simulating the wading event may comprise solving turbulence using a shear stress transport model.

Transient pressures at one or more locations on the vehicle domain may be calculated.

Motion of the second mesh through the first mesh may comprise a combination of rotation and translation motion. Coordinate systems at front and rear axles of vehicle may be defined. The coordinate systems may be maintained to be parallel with the ground of the trough domain.

According to a second aspect of the invention there is provided a system for performing a computer implemented analysis of a vehicle in a simulated wading event, the system comprising: an input arranged to receive data relating to a vehicle and a trough region to be waded by the vehicle; a processor arranged to: define a trough domain representing the trough region comprising a water level to be waded by the vehicle; define a vehicle domain comprising a simulation of the vehicle; generate a first mesh comprising a plurality of finite mesh elements representing the trough domain; generate a second mesh comprising a plurality of finite mesh elements representing the vehicle domain; define an overset between the first and second meshes; simulate the wading event by moving the second mesh representing the vehicle domain through the first mesh representing the trough domain, resolve the forces on at least a subset of the finite mesh elements to obtain transient pressures on at least a part of said vehicle domain, and an output arranged to output data indicative of said transient pressures.

According a third aspect of the invention there is provided a method of assessing the performance of a functional part of a vehicle during a wading event, the method comprising: modeling the surface of the vehicle, the model comprising the functional part to be tested; simulating the wading event according to the method of the first aspect of the invention; obtaining transient pressure data from the simulation of the wading vehicle; modeling the effects of the transient pressure data on the functional part; determining loading data on the functional part from the transient pressure modeling; assessing the performance of the functional part from the determined loading data.

Assessing the performance of the functional part may comprise comparing the performance of the assessed functional part with previously assessed functional part designs.

Assessing the performance of the functional part may comprise comparing the determined loading data with physical testing data.

Modeling the surface of the vehicle may comprise stitching gaps in the surface of the vehicle to create a water tight assembly.

According to a fourth aspect of the present invention there is provided a system for assessing the performance of a functional part of a vehicle during a wading event, the system comprising: an input arranged to receive data relating to a vehicle and a trough region to be waded by the vehicle; a processor arranged to: model the surface of the vehicle, the model comprising the functional part to be tested; simulate the wading event according to the system of the second aspect of the invention; obtain transient pressure data from the simulation of the wading vehicle; model the effects of the transient pressure data on the functional part; determine loading data on the functional part from the transient pressure modeling; assess the performance of the functional part from the determined loading data; an output arranged to output a performance indication for the functional part.

Additionally, a computer program product may comprise computer readable code for controlling a computing device to carry out the method of the first and/or third aspects of the present invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a moving domain

FIG. 2 shows a moving domain at different time instances

FIG. 3 shows a mesh morphing approach

FIG. 4 shows an overset mesh in accordance with an aspect of the present invention (Overset mesh approach)

FIG. 5 shows the location of pressure transducers

FIG. 6 shows a CAD model of block and tank domain

FIG. 7 shows mid-plane cross section of domain mesh

FIG. 8 shows a simulation model of block and tank domain

FIG. 9 shows co-relation of peak pressure data (in mm of H 0) at sensor locations for 180 mm, 1.85 m/s

FIG. 10 shows co-relation of transient pressure data (in Pa) in sensor 6 (base centre) at 180 mm, 1.85 m/s

FIG. 11 shows a test clip taken at immersion depth 180 mm and speed 1.85 m/s

FIG. 12 shows a simulation clip at immersion depth 180 mm and speed 1.85 m/s

FIG. 13 shows sensor location (white marks) on undertray

FIG. 14 shows experimental testing of vehicle

FIG. 15 shows vehicle motion and wheel rotation in accordance with an embodiment of the present invention (Motion definition of vehicle and wheels)

FIG. 16 shows co-relation of transient pressure data in sensor 2 (undertray) at 450 mm, 1.944 m/s

FIG. 17 shows co-relation of peak pressure data on sensor location for undertray at 450 mm, 1.944 m/s

FIG. 18 shows co-relation of peak pressure data on sensor location for undertray at 200 mm, 3.33 m/s

FIG. 19 is a bar chart comparing simulated pressures on an under-tray component with pressures measured in a test (Co-relation of peak pressure data on sensor location for undertray at 250 mm, 4.167 m/s)

FIG. 20 shows simulated pressures on an under-tray functional part (Mapped Static pressure on structural mesh at T=0.675 sec)

FIG. 21 shows loading stresses on the under-tray component of FIG. 20 (Von Mises stresses on undertray at T=0.675 sec)

FIG. 22 shows a simulation of a vehicle within a wading trough in accordance with an aspect of the present invention;

FIG. 23 is a flow chart of a testing process in accordance with an embodiment of the present invention;

### DETAILED DESCRIPTION

The present invention provides a method of modeling the motion of a vehicle through a body of water. Modeling the vehicle according to aspects of the present invention provides the ability to test the effects of wading on vehicle functional parts such as under-tray components.

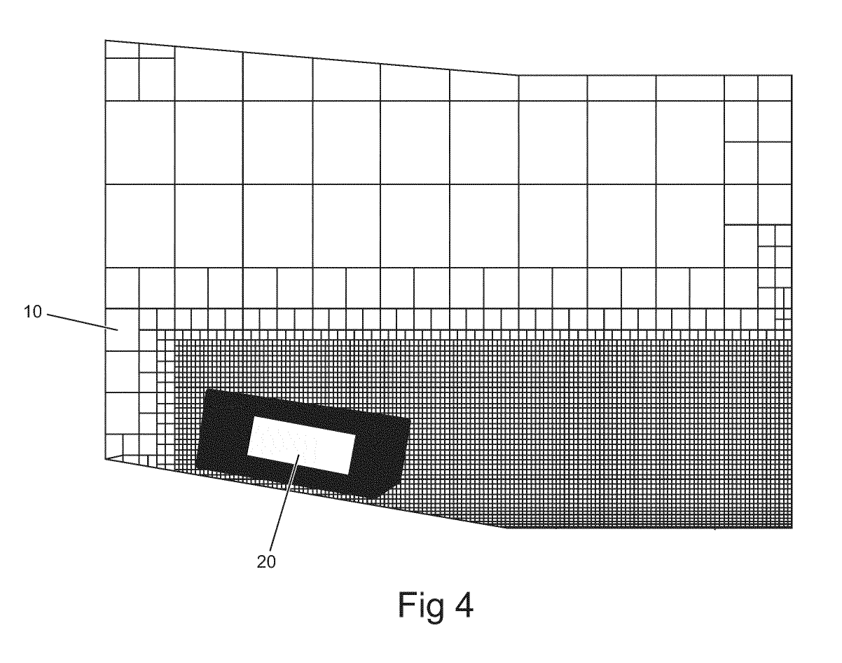

The present invention utilizes an overset mesh (Chimera) technique in which two different domains 10, 20 are modeled (see FIG. 4). The domain with the object of interest (the vehicle, referred to as the vehicle domain 20 below) is meshed separately to the background domain 10 (referred to as the trough domain).

Within the vehicle simulation according to the present invention, at every time step when the field grid (vehicle domain) moves over the background grid (trough domain), the region of the background grid overlapping with the field grid may be cut out leaving only the fringe cells (or acceptor cells) of the cut region in the background grid. Likewise, the outer cells of the field grid may also be acceptor cells. The acceptor cells of both grids may be used to couple the two grids through the use of interpolation in order to allow two way communications between the vehicle domain and the trough domain.

The overset mesh technique has the advantage of being robust with respect to large amounts of motion as well as complex motion. Furthermore, mesh motion handling needed comparatively less computational effort and, in turn, the computational run time was relatively less for the overset mesh technique in accordance with an embodiment of the present invention compared to other available modeling techniques such as mesh morphing and re-meshing and moving domain approaches.

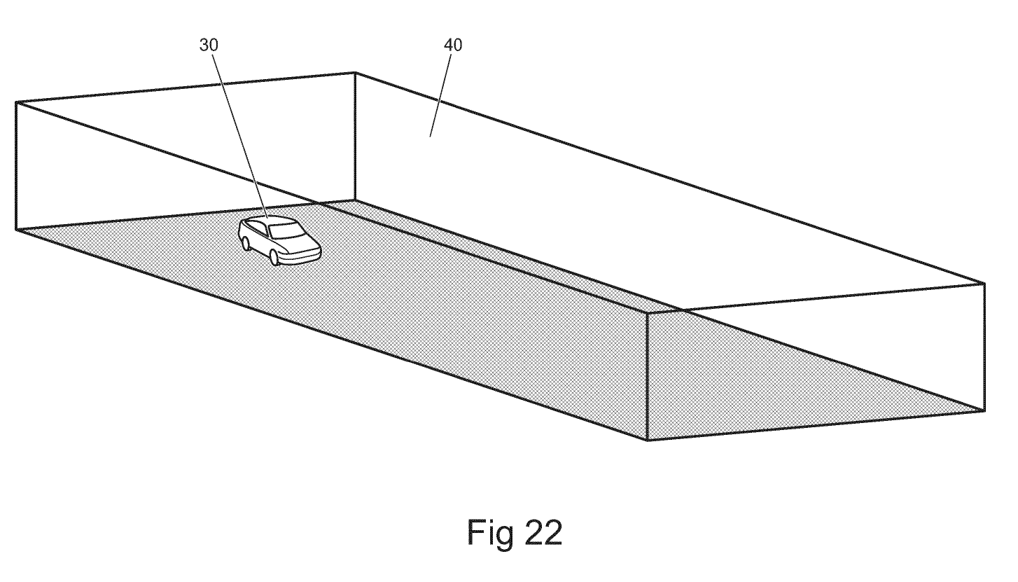

FIG. 22 depicts a simulated vehicle 30 within a trough 40 that represents the region where wading occurs in the simulation (the trough domain 10).

For wading, the surface of the trough domain may be modeled as a wall with no-slip boundary conditions. The other five sides of the wading trough 10 domain may be modeled as pressure outlet at atmospheric boundary conditions.

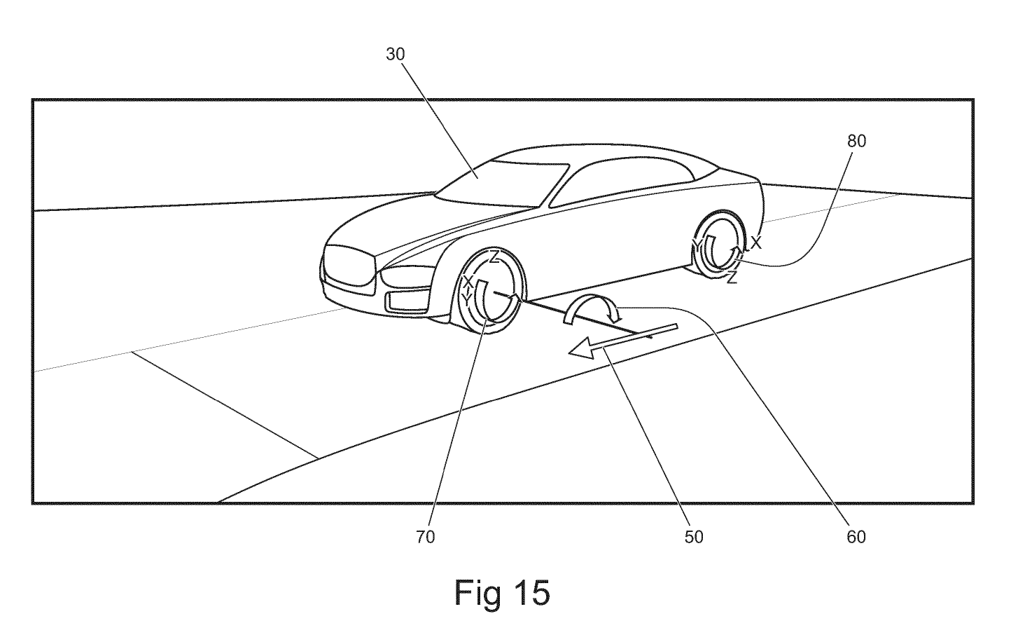

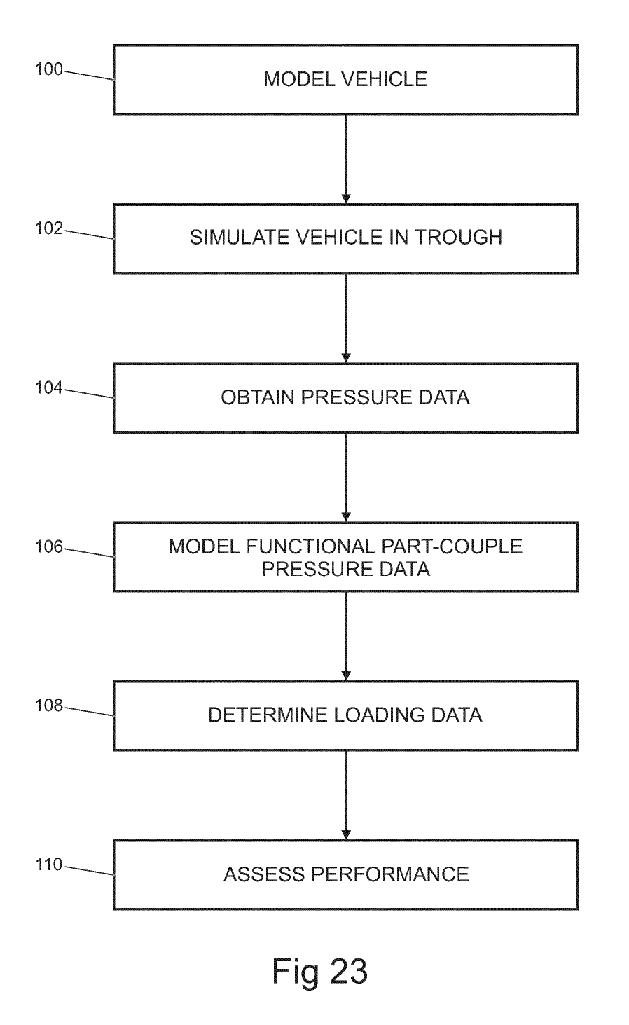

FIG. 23 depicts a method of testing a functional part of a vehicle 30, for example an under-tray component during a simulated wading test. FIG. 15 additionally shows motion of the vehicle within the overset mesh approach.

In step 100 of FIG. 23 the vehicle 30 is modeled. The surface mesh model of the vehicle may comprise data from a computer aided engineering database. The model may be suitably cleaned for use in the testing method of FIG. 23 by, for example, stitching gaps in the vehicle body to create a water-tight assembly. The surface mesh data from the CAE database may be imported to Hypermesh (a high-performance finite element pre-processor that provides a highly interactive and visual environment to analyze product design performance) and ANSA (is a computer-aided engineering tool for Finite Element Analysis and CFD Analysis widely used in the automotive industry). It is noted that when cleaning the mesh model, it is important to keep geometrical details that might be important to the results of the testing process, for example under-trays, wheel arch liners etc. It is also important to not include too many details that make the computational model unnecessarily big. An example of the size of the elements within the model is shown in Table 1 below.

TABLE 1
Characteristic length of element size of
triangular surface mesh in HYPERMESH

| Area | Characteristic length (mm) |
|---|---|
| Exterior surface | 10 |
| Front Grill | 2 |
| Engine & Transmission | 5 |
| Cooling packs | 5 |
| Floor | 5 |
| Under trays | 5 |
| Wheels arches | 3-5 |
| Wheels & Suspension assm. | 5-10 |
| Global mesh | 20 |

In step 102, the area that the vehicle is to be simulated moving though may be defined as a trough domain 10. Additionally the vehicle may be defined within a vehicle domain 20.

As discussed above in relation to FIG. 4, two different domains 10, 20, one housing the vehicle and the other representing the trough domain may be created to allow an overset mesh modeling technique to be employed. A hexahedral dominant mesh may be generated in both domains. Prism layers may also generated on the vehicle domain surface to resolve the boundary layer.

In addition to the vehicle and the trough domains, separate domains for other vehicle components such as the intercooler, condenser and radiator (the coolpack) may be defined in order to solve porous media physics in these regions.

In the vehicle domain normal physics is solved, while in the coolpack domain regions porous physics may be additionally solved along with the normal physics. The coolpack components and the vehicle region may be connected by the front, rear and side faces of the porous media core and internal interfaces at these boundaries may be defined. The interfaces may be defined as being non conformal and information exchanged between the vehicle and the coolpack regions using interpolation. The wheels are kept floating to permit local rotation. A hexahedral dominant mesh may be generated in all the domains (vehicle, coolpack, trough domains).

Certain components of interest (such as undertrays) may be meshed with prism layers to resolve the boundary layer and the vehicle domain suitably refined to capture the near object flow physics.

Three mesh refinement regions may be created. In a first refinement region, the region of the trough domain through which the vehicle moved may be refined to capture the flow physics and more importantly to reduce interpolation errors during the overset mesh process.

A second refinement area v defined around the coolpacks to accurately capture the flow physics in this area.

A third refinement area may be defined in the region occupied by the water in the trough in order to help capture the transient water/air interface accurately.

A segregated implicit unsteady solver may be selected to resolve a flow field around the vehicle, a volume of fluid (VOF) model used to solve the multiphase flow physics and a shear stress transport model (K-Omega SST) used to solve the turbulence.

Porous inertial and viscous resistance coefficients can be calculated from experimental test data of pressure drop versus velocity for the coolpacks and to solve the porous physics in the coolpack region.

Side and upper boundaries of the trough domain may be modeled as pressure outlets. A field function may be hooked to the VOF model to supply the initial water level as in the case of the block and the tank.

The motion of the vehicle as it moves through the trough is a combination of rotation and translation motion. Co-ordinate systems may be defined at the front and rear axles of the vehicle and moved with the vehicle (see FIG. 15) such that the front and rear axle co-ordinate systems are maintained parallel with the ground. The motion of the vehicle is defined using the axis on the front axle. The vehicle is translated along the positive y axis of the front axle co-ordinate system and rotated about the x axis when it approaches the trough as shown in FIG. 15. This is made possible by using a time dependent rotation rate. This entire motion profile may be applied to the overset mesh using the rigid body motion solver. The wheels of the vehicle are also given a tangential velocity boundary condition which is defined using a local rotation rate about the front and rear axle co-ordinate systems.

Within FIG. 15 the following is noted, arrows 50 and 60 define the vehicle motion (vehicle overset domain). The straight arrow 50 defines the linear motion of the vehicle, whereas the curved arrow motion (arrow 60) defines the vehicle rotation as it moves over the slope. (The vehicle has to correct its position when it moves over the slope as the slope angle decreases as it approaches the trough throat.) The arrows 70 and 80 define the wheel rotation rate. Wheel motion was defined in a Moving Reference frame within the vehicle domain mesh (in other words it was given a local tangential velocity relative to the mesh).

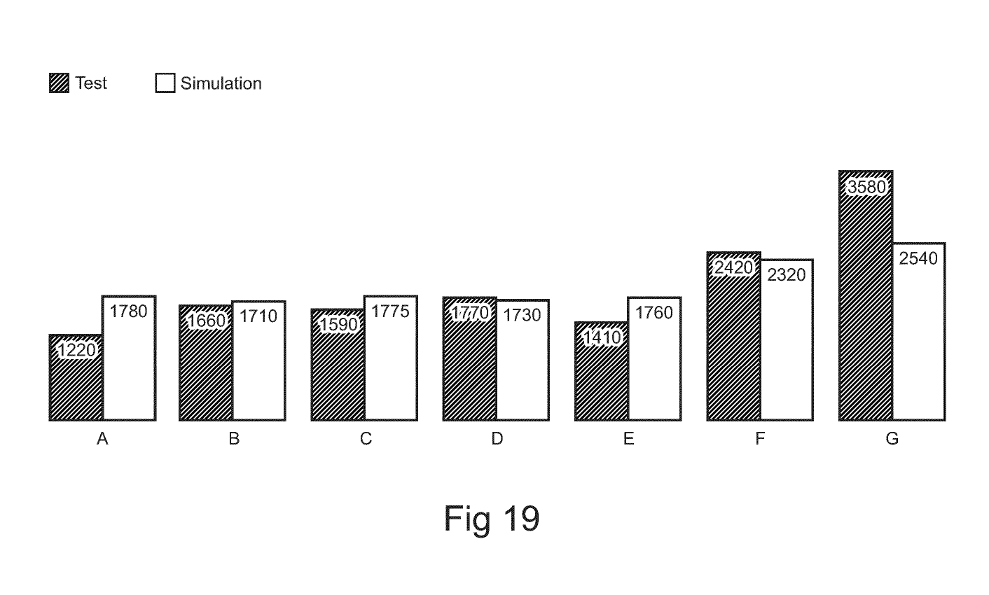

The overmesh model generates transient pressure data as the vehicle is moved into and through the water within the trough region. In the modeled test (see discussion in relation to FIGS. 19 to 21 below) the pressure was monitored at sixteen different locations on the underfloor components and front bumper of the vehicle. This pressure data may be obtained in step 104.

At step 106 the transient pressure data may be coupled to functional parts of interest on the vehicle via a further model.

Loading stresses on the function part of the vehicle may then be determined in step 108 and the performance of the function part assessed in step 110. A number of functional parts may be modeled and tested according to the testing method of FIG. 23 and the relative performances of the functional parts compared. For example, different design options for a new under-tray component for a vehicle may be tested and the output of the test may be used to direct physical testing. In this manner the designs may be rated prior to physical testing and poorly performing designs can be dropped from consideration.

FIG. 19 shows a comparison between transient pressure data generated in accordance with the present invention and pressure data measured during a test of a real vehicle in a wading pool. It can be seen that there is close correlation between the test and the simulation.

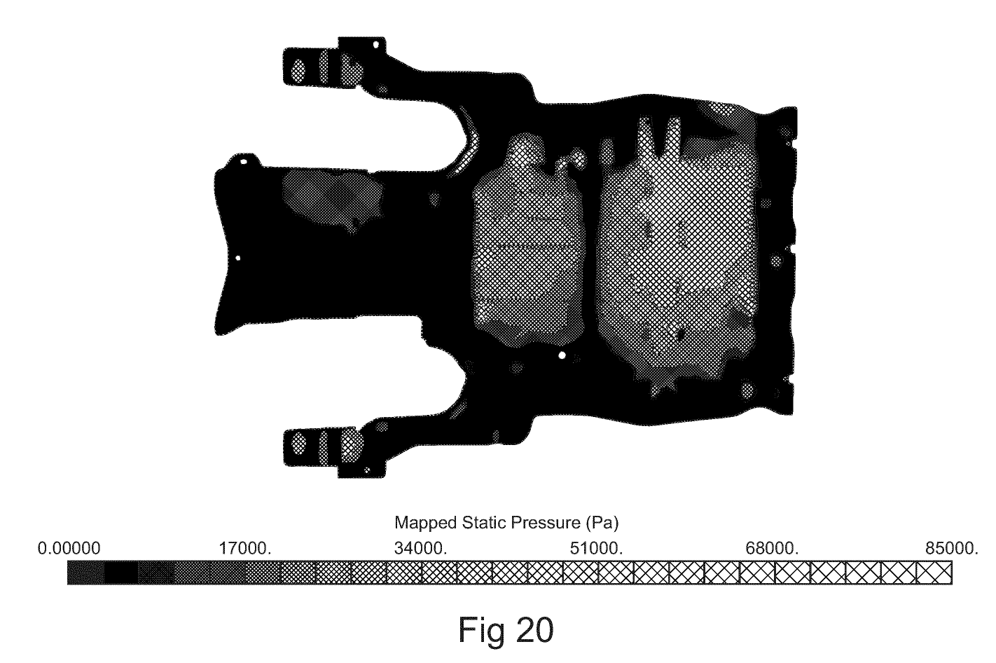

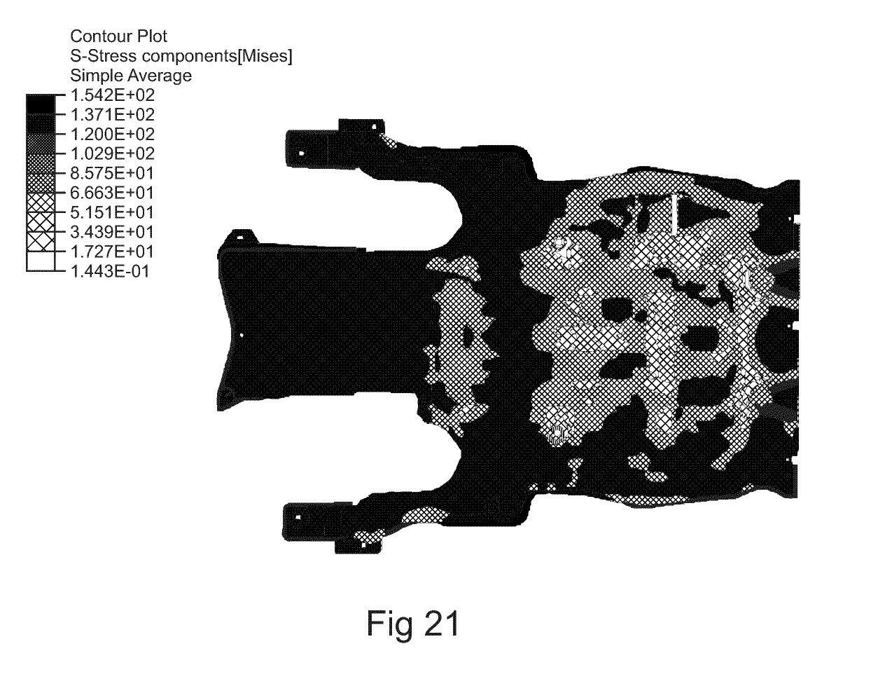

FIGS. 20 and 21 show, respectively, the simulated static pressures on a structural mesh representing a vehicle under-tray component and the stresses on the same component.

Pressure data on the under-tray component as seen in FIG. 20 generated from steps 12 and 14 of FIG. 23 was mapped at various time intervals onto its corresponding structural mesh. This mapped pressure data was taken as a transient load input into a finite element analysis (FEA) structural solver and the loads at the fixtures were obtained. High stress areas and deflection of the component were also obtained as seen in FIG. 21.

Further aspects of the invention are described below:

Vehicle water wading capability refers to vehicle functional part integrity (e.g. engine under-tray, bumper cover, plastic sill cover etc.) when travelling through water. Wade testing involves vehicles being driven through different depths of water at various speeds. The test is repeated and under-body functional parts are inspected afterwards for damage. Lack of CAE capability for wading equates to late detection of failure modes which inevitably leads to expensive design change, and potentially affects program timing.

It is thus of paramount importance to have a CAE capability in this area to give design loads to start with. Computational fluid dynamics (CFD) software is used to model a vehicle travelling through water at various speeds. A non-classical CFD approach was deemed necessary to model this. To validate the method, experimental testing with a simplified block was done and then verified with CFD modeling. The simple rectangular block at two different speeds and three immersion depths in water was utilized for the purpose. As a next step a full vehicle test was conducted and was used to validate the simulation method. Fluid structure interaction and coupling between MBS model of the vehicle and CFD loads is also explored.

Vehicle wading at different depths of water and at different vehicle speeds is an important test procedure for a vehicle development program at Jaguar Land Rover (JLR). The test procedure looks at various vehicle attributes for failures and functionality. As the development of a vehicle program progresses, test results can give open ended answers for functionality and failures. We at JLR needed some virtual world support to understand the failure modes and effect on functional performance. We set aside the failures which were high hurt and focused on those. The high hurt issues were the failures of under body panels. This enabled us to identify initial targets to understand the failure mode of the under body panels.

The first target was to understand the physical testing. The vehicle wading test is done at Millbrook proving grounds which has a wading trough with an inlet ramp and exit ramp. The wading test procedure at JLR is done for a combination of speeds and depths. The vehicle approaches the water trough at constant speed and enters the trough over the ramp. The impact force on the vehicle when it reaches the trough is of a large magnitude. The various test scenarios exhibit different behaviors. The low depth water and high speed test runs see high splash pattern and the vehicle maintaining the entry speed. A bow wave is seen in the front of the vehicle. The high depth and high speed runs have different splash pattern. The initial splash is bigger however as the vehicle decelerates the splash diminishes and at a much slower speed a front bow wave pattern is seen.

We looked at the capabilities of various CAE tools to model this scenario such as LS DYNA, STAR CCM+, and smoothed particle hydrodynamics (SPH).

LS DYNA has a fluid flow model which can be utilized however it has no proven track record about its fluid solver. The solver is based on finite element method and does not have many turbulence models which are one of the main drawbacks. The turbulence model will be of importance because it will play a role in modeling splash in wading analysis. There may be some limitations of LS DYNA as opposed to CFD while obtaining blast peak pressure, in particular the peak pressure may be under predicted using LS DYNA.

Smoothed-particle hydrodynamics (SPH) is a computational method used for simulating fluid flows. It is a meshfree Lagrangian method. SPH computes pressure from weighted contributions of neighboring particles rather than by solving linear systems of equations. And this makes the pressure results dependent on the number of particles used to model the flow physics. And with more of number of particles it becomes computationally intensive and expensive.

The Star CCM+ code is finite volume based code. The flow physics is solved by the linear equations to obtain flow filed and pressure field. It has vast array of turbulence models available to model the turbulent flow. And it is proven CFD tool in its field.

After looking at the background of these codes and their capabilities, the clear winner was the CFD code STAR CCM+.

On scrutinizing the physical test we observed that the failure modes (and hence pressure field) were very dynamic and transient in nature. As the vehicle entered water the under floor components were subjected to impact load and then the vehicle decelerated. So the pressure field was very different from pressure fields obtained from classical CFD modeling (Object is stationary and fluid is moving). To obtain the exact dynamic transient results, the motion of the object needed to be modeled in CFD. The motion would give the transient pressure field which would help us understand the failure modes and the splash patterns at different wading speeds and depths of water.

Historically the vehicle wading work literature is limited. Most of the work conducted is test procedures during the vehicle development programs. Some reports in different forums exhibit only the water level management in and around the under hood compartment and air intake system.

Modeling the motion of the object in CFD was one of the biggest challenges. However due to recent developments in the CFD world, we were optimistic of finding a robust and efficient motion modeling technique. We started exploring the moving mesh techniques in Star CCM+. The aim was to get a motion modeling technique to model the motion of vehicles which would be close to the test scenario as well as be robust and efficient with respect to the transient conditions, physics involved, turnaround time and the results expected. Some of the modeling techniques considered are as follows:

### 1. Moving Domain

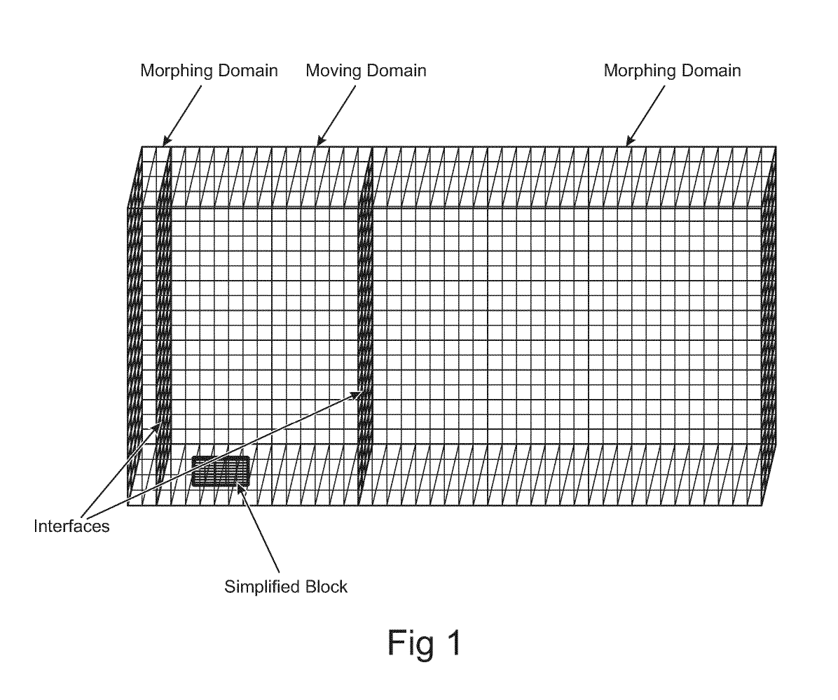

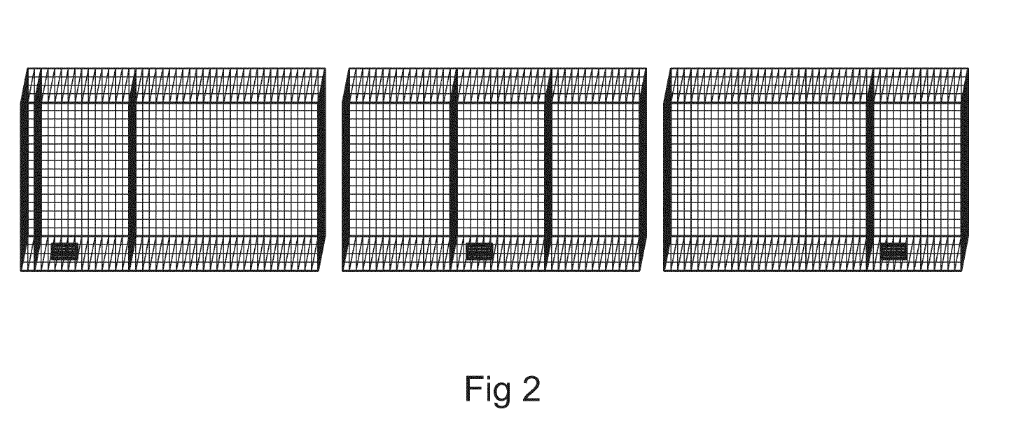

The first approach consisted of modeling the object in a separate domain to which a velocity was imparted. The domains trailing and leading the moving domain were allowed to morph by expanding and compressing the mesh respectively. The internal interfaces between the moving and the morphing domains were used to exchange data between them [FIG. 1 and FIG. 2].

The motion worked well however this method had a number of problems. Since re-meshing or re-layering would complicate and increase the run time, the leading domain would go on compressing the layers of the mesh and finally fail. Likewise, the trailing domain would expand to a very large volume cells making it impossible to capture the wake region. More so, the morphing domain would not morph with change in elevations (i.e. as vehicle enters and leaves the water trough) leaving this method incapable of resolving the test scenario. Secondly, since the whole of the domain in which the object was present was moving the water-air interface did not develop as expected. Both of the above issues, led to poor capturing of flow physics.

### 2. Mesh Morphing

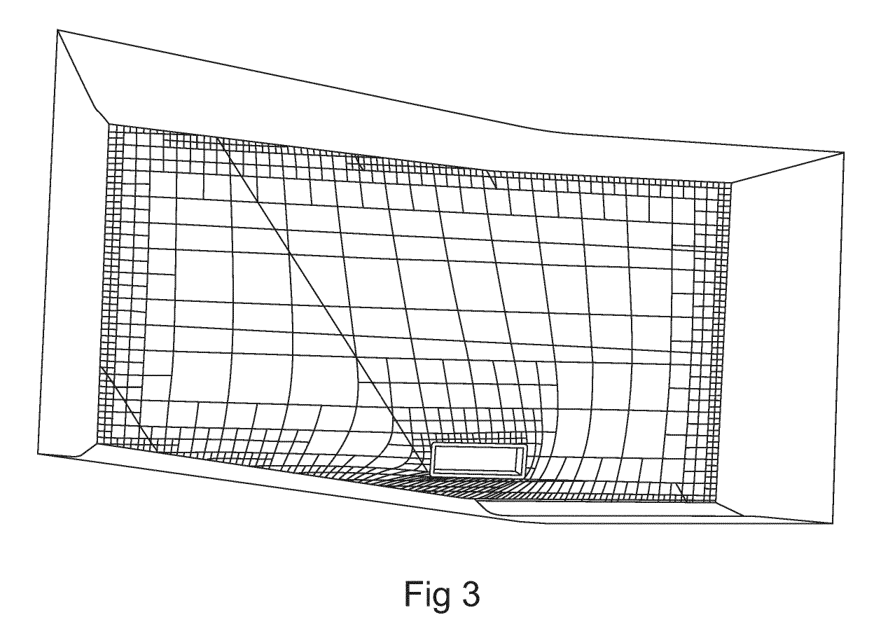

The second approach was relatively straight forward. The object was imparted with the rigid body motion and the mesh around the object was allowed to morph. The main problem of this method is that it worked well for simple and small amount of motion but in the case of larger and complex motions and sharper 3D feature angles (as in a vehicle), the mesh failed after degenerating the cells [FIG. 3].

### 3. Mesh Morphing and Re-Meshing

The third approach took the second approach as initial step and then a macro was written for remeshing the domain which was run dynamically. A script was written for checking the face validity at every time step. The condition for a good quality cell was that the face normal should point away from the attached cell centroid. A face validity of 1.0 meant that all face normals were properly pointing away from the centroid while values below 1.0 meant that some portions of the face were not properly pointing away from the centroid, indicating some form of concavity. If the face validity was breached (i.e. less than 0.8) the script would re-mesh the whole domain and continue the solution from the last time step else it would continue directly to the next time step. This approach worked well.

However the looping and re-meshing was very computationally intensive and thus was not practical for very large displacements of bodies as in our case.

### 4. Overset Mesh

The fourth approach was the overset mesh (Chimera) technique. The modeling of this technique needed two different meshes. The domain with the object of interest (referred to as the field grid) was meshed separately, whereas the background domain (referred to as the background grid) was meshed separately [FIG. 4]. At every time step when the field grid moved over the background grid, the region of the background grid overlapping with the field grid would be cut out leaving only the fringe cells (or acceptor cells) of the cut region in the background grid. Likewise, the outer cells of the field grid were also acceptor cells. The acceptor cells of both grids would be used to couple both the grids implicitly through the use of interpolation. Thus two way communications between the field and the background grid was possible.

The overset mesh showed promising results. It was robust with respect to large amounts of motion as well as complex motion. Mesh motion handling needed comparatively less computational effort. In turn the computational run time was relatively less for overset mesh. This technique had all positive outcomes for application of large motion with reduced computational effort. Care had to be taken that certain meshing and time step criteria were satisfied for it to perform properly.

It was thus decided to use overset meshing to model the motion of the object through the domain

In order to validate the non-traditional approach we decided to prepare a scaled down model in the lab. Guidelines around one of our vehicle were drawn and 1:5 scaled down rectangle was prepared. The motion model in CFD performed robustly with promising initial results. We placed pressure sensors at six different locations and compared pressure measured at various locations.

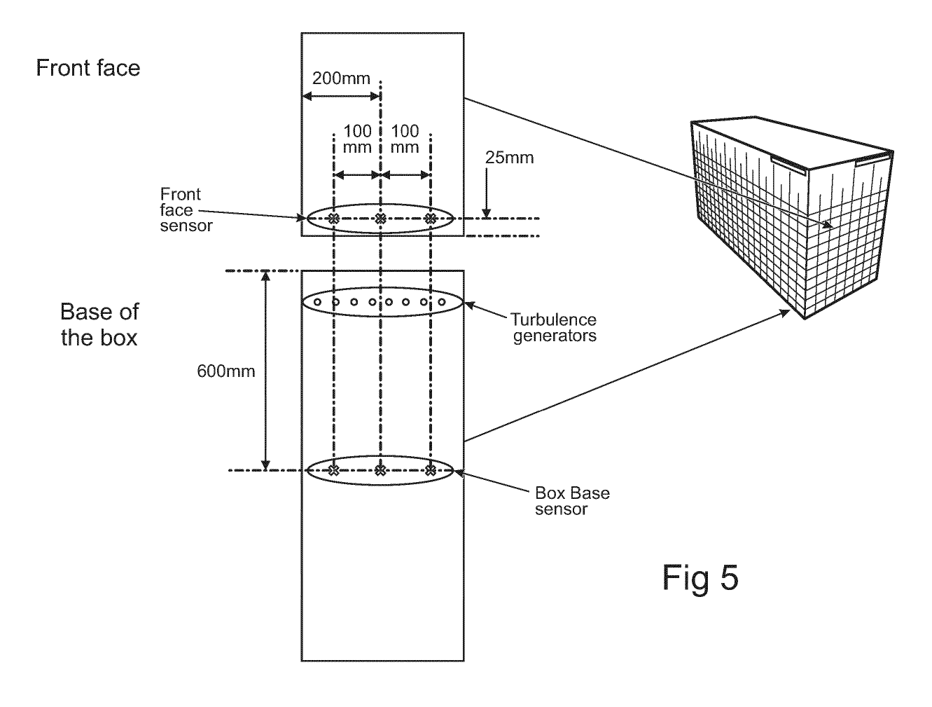

The test was conducted at the Wolfson Unit in University of Southampton using a towing tank setup. A simplified rectangular block was constructed from 12 mm thick acrylic sheet, scaled 1:5 times the vehicle dimensions. However the experimental setup constrained the height of the block to 500 mm. so the final dimensions of the box were 1000 mm×400 mm×500 mm. The speed and the depth of the tests were also scaled down compared to original test conditions. Thus, tests were performed at water depths of 50 mm, 100 mm and 180 mm, each at speeds of 0.87 m/sec and 1.86 m/sec. The test was carried out in a tank (60 m×3.7 m.×1.8 m). Turbulence stimulating pins were positioned round the girth 50 mm aft of the leading face of the box, each at 25 mm centers. The pins were cylindrical, 0.54 mm high and 3.15 mm in diameter and can be seen in FIG. 5. The block had six diaphragm pressure transducers, three on the front face and three on the base of the block and were 3 mm in diameter. They were positioned flush to the block surface and can be seen in FIG. 5. Pressure readings from these sensors were collected by the data acquisition system and were stored as whole time history data, thus allowing the average values to be obtained. A grid was also drawn on the sides of the box to allow the wave profile to be determined. The grid consisted of vertical and horizontal grading lines equi-spaced from the base at 40 mm and 50 mm respectively. In addition to the measurements, still photographs of the block were taken when the test was underway and a motion video was captured at each combination of speed and immersion to observe the bow wave formation and water levels at different locations on the block. The block was also mounted on dynamometers which measured drag and lift forces as well as pitch moment. The block was fixed in space with zero yaw, pitch and roll angle (orthogonal to the tank axes) at various water depths.

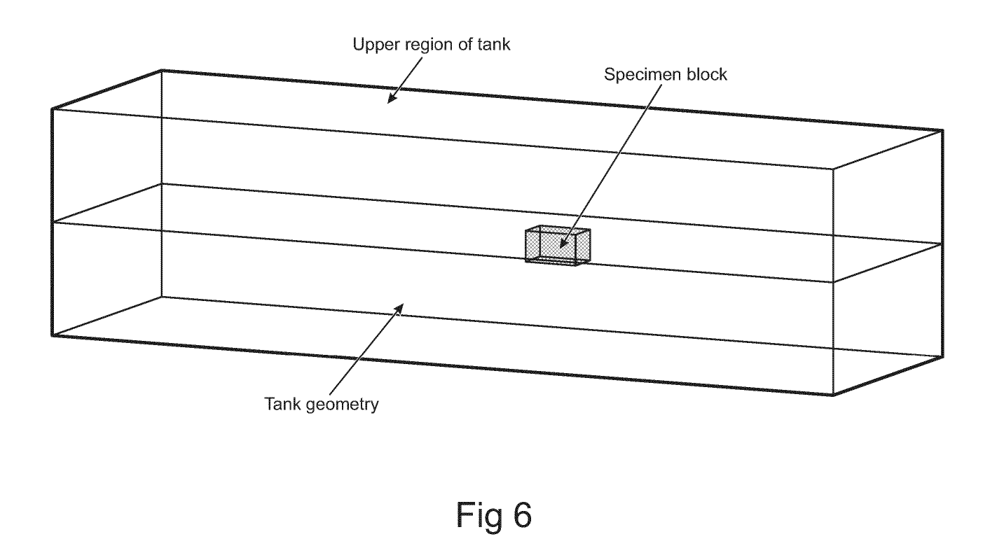

Similar to the test setup, a three dimensional geometric CAD model of the block and tank was built in ANSA. Instead of modeling 60 meters of the tank domain only 15 meters were modeled since a fully developed flow around a block would be attained within a travelling distance of two or three meters of the block. The region of the tank above the block was taken into consideration and the air domain above the tank was modeled for a height equivalent to the tank depth [FIG. 6]. The block was modeled with the same dimensions as in the test. The CAD model was imported in the CFD software for meshing.

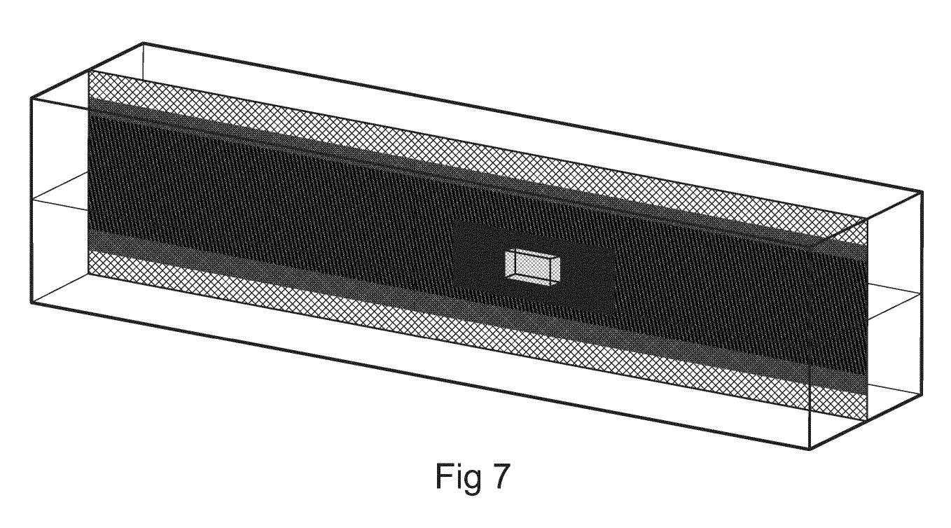

A box was modeled around the block to have the overset mesh successfully defined around the block and tank. Two different domains one housing the block and the enclosing box and the other housing the tank were created for overset meshing. A hexahedral dominant mesh was generated in the both the domains. Prism layers were also generated on the block surface to resolve the boundary layer. The block domain was suitably refined to capture the near object flow physics. Likewise, the region of the tank domain through which the block would pass was suitably refined to capture the flow physics and more importantly to reduce the interpolation error during the overset mesh process [FIG. 7]. The total mesh count was 20.88 million.

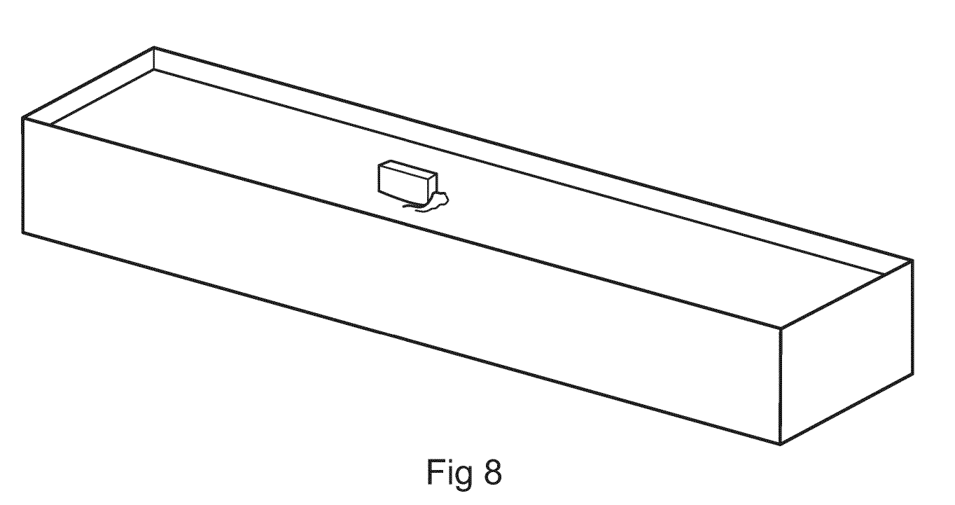

A segregated implicit unsteady solver was selected to resolve a flow field and pressure field around the block. To better resolve the turbulent flow near the wall as well as in the far field, the SST K-Omega model was used. The SST K-Omega model is used a lot in marine CFD since it blends a K-Epsilon model in the far-field with a K-Omega model near the wall. An overset mesh was defined between the tank domain and the block domain and a linear motion for the block moving through the tank was solved with a rigid body motion solver. A volume of fraction (VOF) model was used to solve the multiphase flow physics and capture the water air interface [FIG. 8]. A field function was hooked to the VOF model to supply the initial water level. Six points at the position of the experimental pressure sensor locations were used as monitors to obtain the transient pressure. In addition to them, drag plots were also recorded for the different speeds and depths of water.

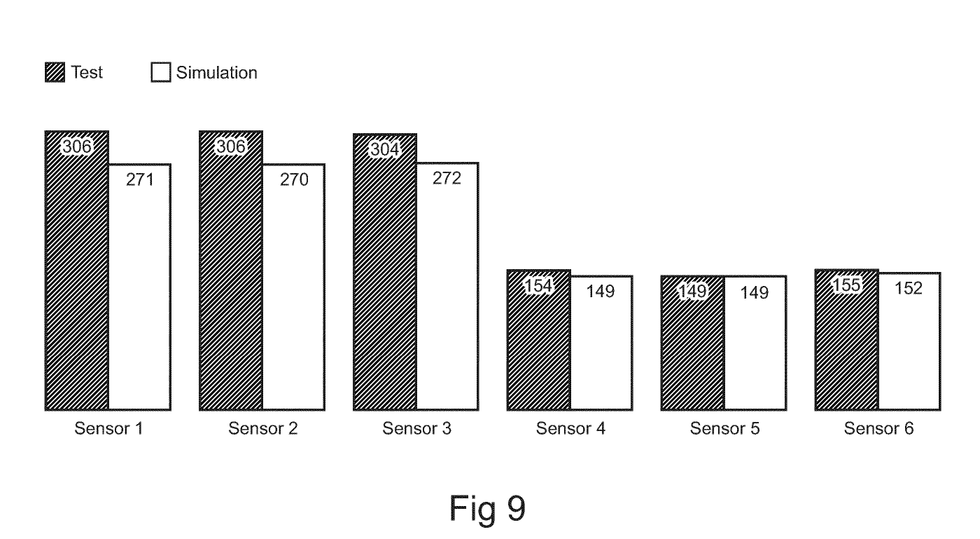

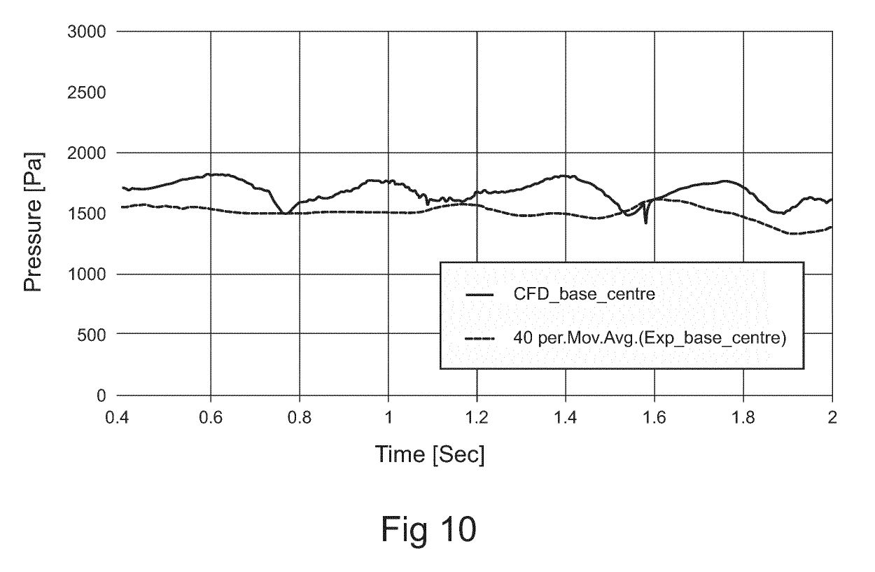

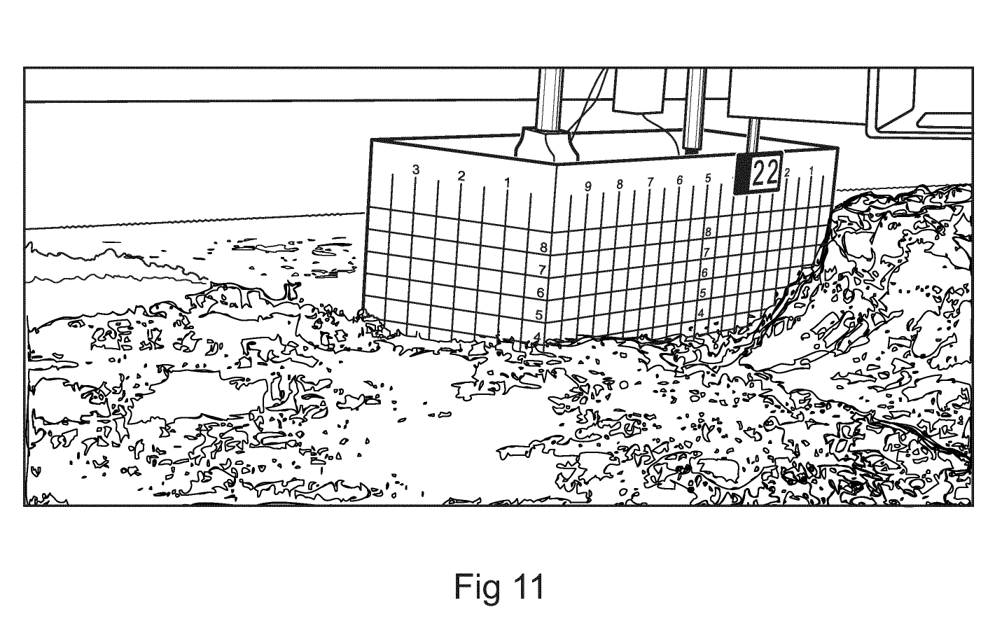

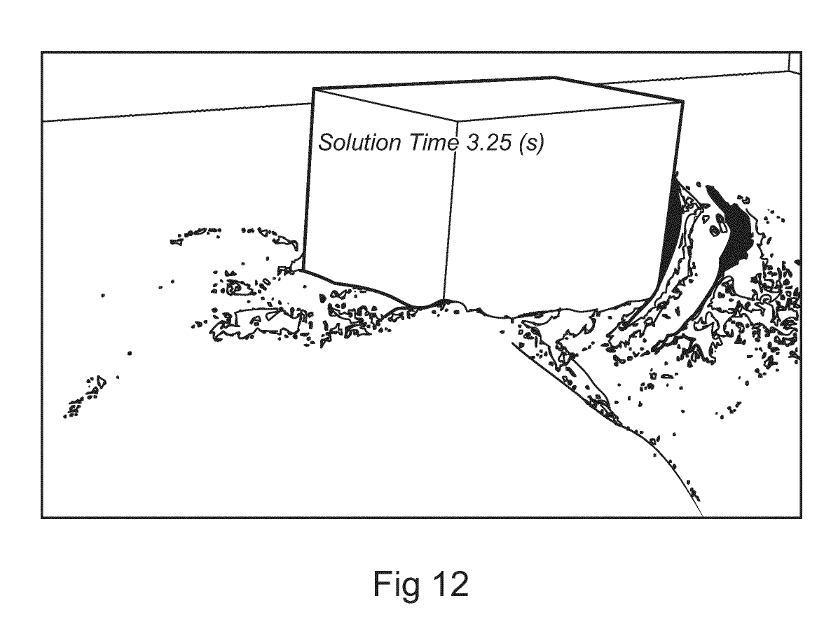

The transient pressure data from the pressure monitors at the sensor locations were obtained from CFD. These were compared with the test pressure readings. The pressure readings from the test were averaged so as to reduce the noise from test signals. The percentage difference between the test and CFD results varied on an average by around 10 percent. The largest margin of error was for the shallow depths, which was 19 percent. The main reason for this comparatively larger discrepancy was due to the splash generated during shallow water wading. Capturing splash was highly mesh dependent as the mesh at that location would have to be much finer than the size of the droplets. FIG. 9 and FIG. 10 show a comparison between experimental data and CFD data for an immersion depth of 180 mm and a speed of 1.85 m/s. The visual attribute of the bow wave formation around the block was compared. FIG. 11 and FIG. 12 show the water level comparison for an immersion depth of 180 mm and speed of 1.85 m/s. This comparison was done by calculating the height of water at two locations, front face centre line and the rear corner. The height from the experiment was calculated by visually inspecting the water level from the photographs recorded during the testing. Visual observations tell us that water level is between lines marked 3 and 4. The lines are equispaced 40 mm apart (0-9), so the height of line 4 is 0.16 mtrs. In CFD the height of the water level is determined by measuring the centerline from the free surface (corresponding to a volume fraction of water equal to 0.5). The value is 0.158 m. The water level comparison was very promising showing a maximum error of 5% and minimum of 1%.

The next stage was to model vehicle wading similar to the real-life test procedure. The CFD model would give us some results; however correlation with the real life test and with the complete vehicle was essential. The next stage started with testing the vehicle by incrementing it and recording the transient pressure data at different locations followed by building the CFD model and co-relating the results.

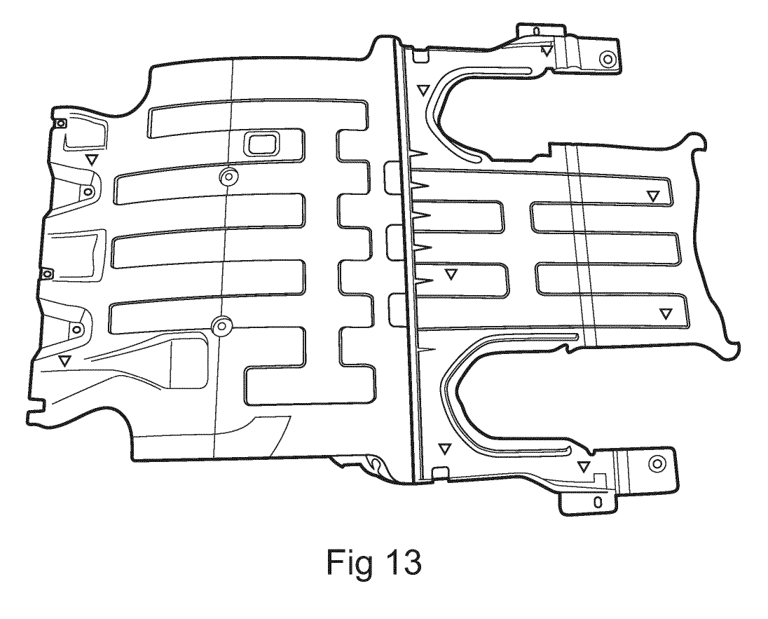

Waterproof pressure transducers were fitted at sixteen locations on the underside panels and bumper of the test vehicle [FIG. 13]. The pressure transducers were capable of measuring up to 93.15 kPA (9.5 mH20) and were mounted such that the sensing diaphragm was parallel to the body panels and recessed approximately 5 mm behind the outer face of the panels. A protective stainless steel mesh was fixed over the diaphragms. The signal conditioning and data acquisition system was mounted in the rear of the vehicle and the signal wires were lead around the bodywork to the pressure transducers. All the signal wires were shielded in order to minimize electrical noise contamination of the signals.

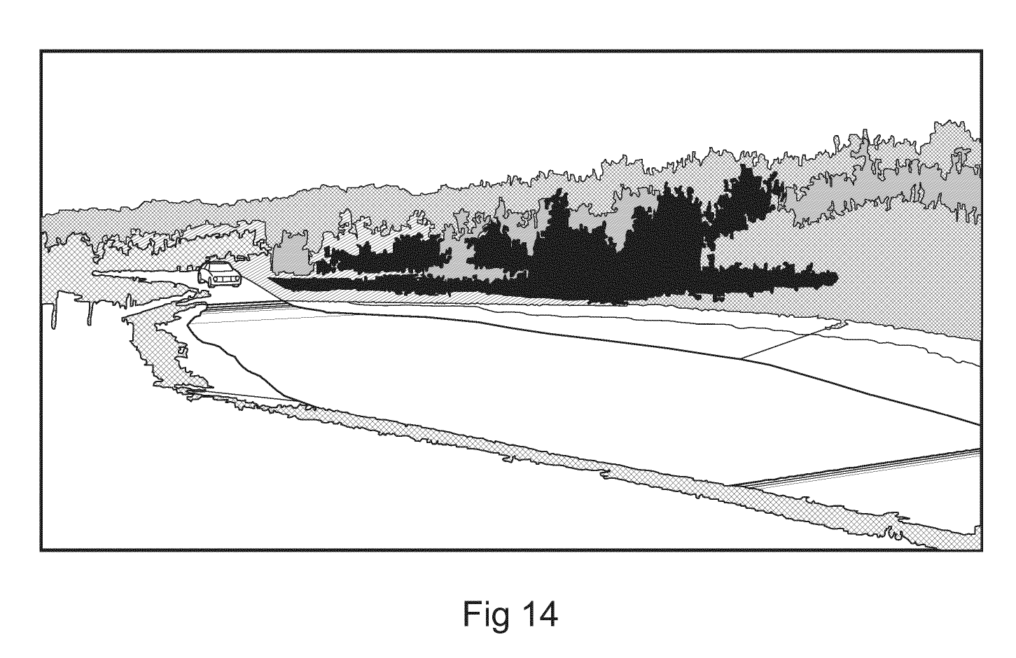

The tests were conducted in the wading trough at Millbrook Vehicle Proving Ground in Bedfordshire [FIG. 14]. The vehicle used was one of the Jaguar XJ. The transducers were ‘zeroed’ while the vehicle was at standstill immediately prior to the test run. The vehicle accelerated up to the required wading speed immediately prior to entering the wading pool and then a constant wading speed was maintained by the driver. Data acquisition commenced several seconds before entering the water and was stopped once the vehicle was clear of the water and had come to a standstill. This procedure was repeated over the test matrix of vehicle speeds and wading depths.

The wading trough was built in a CAD software resembling the one used for the test. The surface mesh model of the vehicle used in the test was received from the crash team. The crashmodel was suitably cleaned for CFD use (such as stitching gaps to create a water-tight assembly) in Hypermesh and ANSA. The vehicle is aligned with the entry ramp of the trough. Both the wading trough CAD data and the vehicle model surface mesh data were imported into STAR-CCM+ for additional surface preparation and volume mesh generation. Similar to the CFD model of the block and tank, a box was modeled around the vehicle to have the overset mesh successfully defined between the vehicle and the trough. In addition to the vehicle and the trough domains, we defined separate domains for the coolpacks (intercooler, condenser and radiator) to solve porous media physics in these regions.

In the vehicle region the normal physics were solved while in the coolpack regions the porous physics were solved along with the normal physics. Since in reality the coolpacks and the vehicle region were connected by the front, rear and side faces of the porous media core, we defined internal interfaces at these boundaries. These interfaces were non conformal and exchanged information between the vehicle and the coolpack regions using interpolation. The wheels were kept floating to permit local rotation. A hexahedral dominant mesh was generated in the all the domains. Certain components of interest (such as undertrays) were meshed with prism layers to resolve the boundary layer. The vehicle domain was suitably refined to capture the near object flow physics. Three mesh refinement regions were created. Similar to the block and tank model, the region of the trough domain through which the vehicle would move was suitably refined to capture the flow physics and more importantly to reduce the interpolation error during the overset mesh process. The second refinement area was defined around the coolpacks to accurately capture the flow physics in this area as well. The third refinement area was defined in the region occupied by the water in the trough. This would help capture the transient water air interface accurately. The total mesh count was 40 million+.

As done with the block and tank, the segregated implicit unsteady solver was selected to resolve a flow field around the vehicle. The VOF model was used to solve the multiphase flow physics and the K-Omega SST model was used to solve the turbulence. Overset mesh was defined between the wading trough and the vehicle domain. The porous inertial and viscous resistance coefficients were calculated from the experimental test data of pressure drop vs velocity for the coolpacks and were used to solve the porous physics in the coolpack region. The side and upper boundaries of the trough domain were modeled as pressure outlets. A field function was hooked to the VOF model to supply the initial water level as in the case of the block and the tank.

The motion of the vehicle as it moves through the trough is a combination of rotation and translation motion. Co-ordinate systems are defined at the front and rear axles of the vehicle and are moved with the vehicle. Thus, the front and rear axle co-ordinate systems are always maintained parallel with the ground. The motion of the vehicle is defined using the axis on the front axle. The vehicle is translated along the positive y axis of the front axle co-ordinate system and rotated about the x axis when it approaches the trough as shown in FIG. 15 This is made possible by using a time dependent rotation rate. This entire motion profile is applied to the overset mesh using the rigid body motion solver. The wheels of the vehicle are also given a tangential velocity boundary condition which is defined using a local rotation rate about the front and rear axle coordinate systems [FIG. 15]. The pressure was monitored at sixteen different locations on the underfloor components and front bumper. These CFD pressure readings were compared to the experimental readings of the test vehicle.

The comparison between transient pressure data of test and CFD at the sensor locations showed percentage errors within acceptable limits. The error margin was expected as the real life scenario involved multi-disciplinary physics which was just partly taken into account by the CFD model.

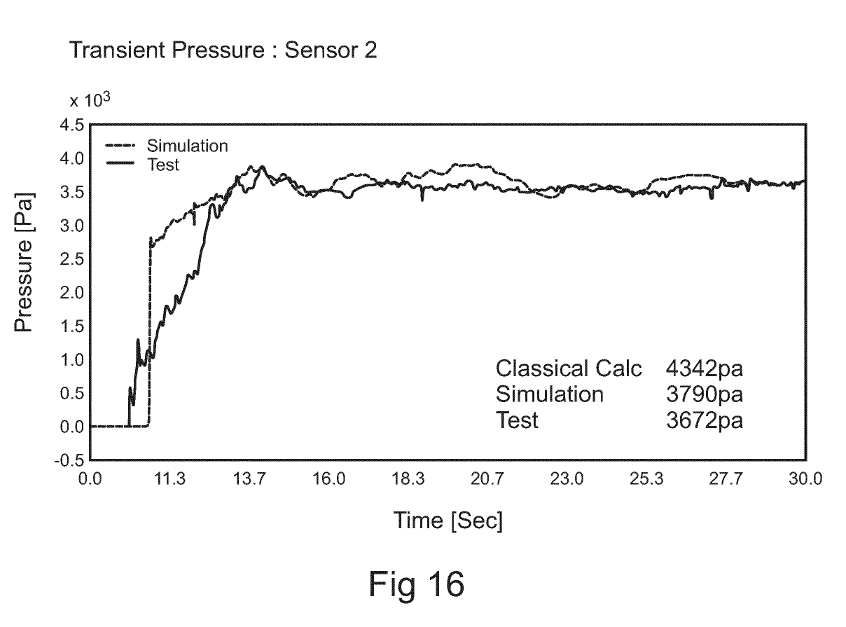

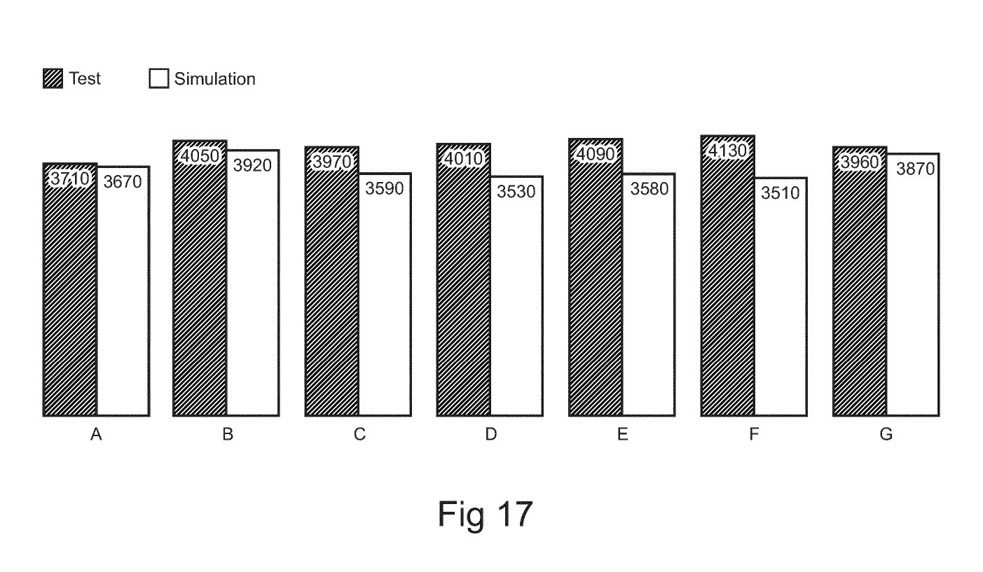

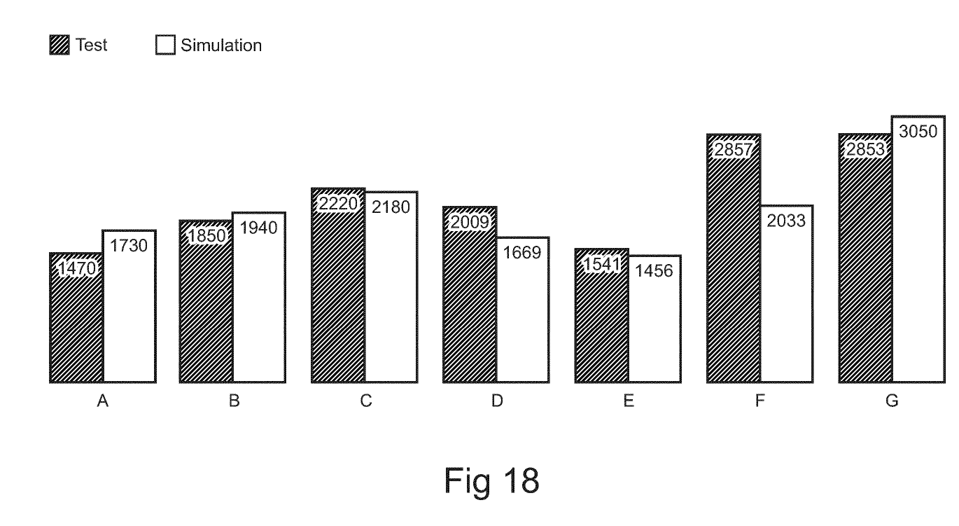

Comparatively larger pressures were recorded by CFD on flexible components (such as the aeroflips) since they were modeled as rigid in CFD whereas during the test these components would deflect upon loading and thus the pressure measured would be less. This discrepancy could be resolved by modeling fluid structure interaction (two way coupling). But for stiff components like the undertray good co-relation was achieved [FIGS. 16, 16, 17 and 18]. The front bow wave seen in the CFD model also showed good agreement with what was seen in the test.

Since aiding structural design of the underbody components for wading was one of the main purposes of this method, obtaining loads at fixtures and high stress areas on the underbody components was the next logical step. To do this, the pressure data on the undertray as seen in FIG. 20 from STAR-CCM+ was mapped at various time intervals onto its corresponding structural mesh. This mapped pressure data was taken as a transient load input into Abaqus, a FEA structural solver and the loads at the fixtures were obtained. High stress areas and deflection of the component were also obtained as seen in FIG. 21. Currently only one way coupling between the fluid and the structure was modeled. To model the flexible behavior of the components and their influence on the surrounding flow field would require the need for two way coupling and would be worked on in the future.

To improve the accuracy of the model and to replicate the jumping behavior when the vehicle moves through the water a co-simulation between Star CCM and Simpack, a Multi Body Simulation software is being performed using a coupling tool called MpCCI, which stands for Multi physics Code Coupling Interface. During the co-simulation the forces and torques experienced by the object as it moves through the fluid are transferred from the CFD to the MBS model which then calculates and transfers the velocities of the object to the CFD model. Currently work is being done to validate the interaction between the softwares using a simplified car model with four wheels.

It was seen that for the block and tank test good co-relation was achieved between the test and CFD results validating the use of the overset mesh to model motion in CFD as well as the other physics models used in the simulation. On the vehicle level as well, the CFD model was able to deliver results in close comparison with the test. Few discrepancies were observed and potential ways to overcome them in the future were also formulated. The first was to work on two way coupling between the CFD and the structural solver as opposed to the current process of one way coupling to capture the pressure field accurately around flexible components. The second was to accurately model the splash and water ingress on components within the engine bay specifically for shallow water depths and high speeds. The third was to model the jumping behavior of the vehicle as it traverses through the water (especially at high speeds and high depths). It would be necessary to couple the CFD model with an MBS model to replicate this behavior. Nonetheless, the above CFD-only results did give us insight into the underbody component loading and potential failure modes. With these insights the design loads for the components could be estimated which could aid structural design of the part for wading during the initial phase of design.

The present invention further provides a method and a system which may be used to model water ingression on components within the engine bay. For this model, the location of water ingression in the structure is observed. For example, for an engine bay, locations of apertures/gaps are of importance from a point of view of engine bay cooling to allow the hot air from the engine bay to vent off as well as guarding the electrical, such as a starter motor and an alternator, and electronic components from water splashing and ingression around the engine. It is possible to model to predict the pressure at the outer interface of the engine bay whilst the vehicle is wading to determine water ingress through any gaps. Modeling the internal structure of the engine bay further increases the accuracy and benefit of the model and obtains more accurate results as the water ingress through one or more apertures is normally accompanied by a resultant splash of water on the electrical and/or electronic components or other components within the engine bay. Accurate geometric modeling of the apertures in the structure enables a prediction of water ingression and the resulting splashing to be reliably obtained. Not only costs are saved, but this prediction can aid in designing and packaging of the components, relative to the vehicle, to predict the performance of the splash guards and the various water ingress locations which can be addressed with a balanced approach of protection of the engine and cooling of the engine bay. The same method and system can be used for modeling water ingression and splash effects on other enclosed spaces within a wading vehicle, for example a transfer case breather.

1. A method of performing a computer implemented analysis of a vehicle in a simulated wading event, the method comprising:
defining a trough domain representing a region comprising a water level to be waded by the vehicle;
defining a vehicle domain comprising a simulation of the vehicle;
the method further comprising:
generating a first mesh comprising a plurality of finite mesh elements representing the trough domain;
generating a second mesh comprising a plurality of finite mesh elements representing the vehicle domain;
defining an overset between the first and second meshes;
simulating the wading event by moving the second mesh representing the vehicle domain through the first mesh representing the trough domain,
resolving the forces on at least a subset of the finite mesh elements to obtain transient pressures on at least a part of said vehicle domain, and
outputting data indicative of said transient pressures.

2. A method as claimed in claim 1, wherein defining the overset mesh comprises determining an overlap region between the first and second meshes and cutting the overlap region out from the first mesh.

3. A method as claimed in claim 2, wherein simulating the wading event comprises stepping the second mesh through the first mesh in time periods, and wherein for each time period, the overlap region is determined and cut out from the first mesh to define fringe cells in the cut overlap region

4. A method as claimed in claim 3, comprising coupling outer cells of the second mesh to the fringe cells of the first mesh.

5. A method as claimed in claim 4, wherein coupling the first and second meshes comprises using an interpolation function.

6. A method as claimed in claim 1, wherein further meshes are generated for each of a plurality of functional parts of the vehicle.

7. A method as claimed in claim 1, wherein the vehicle domain defines at least one functional part of the vehicle, the method comprising defining a prism layer between the functional part of the vehicle in the vehicle domain and the first mesh representing the trough domain.

8. A method as claimed in claim 7, comprising resolving a boundary layer within the prism region.

9. A method as claimed in claim 1, comprising creating a first mesh refinement region corresponding to a region of the first mesh representing the trough domain through which the first mesh representing the vehicle domain is to be moved.

10. A method as claimed in claim 1, comprising creating a second mesh refinement region corresponding to region surrounding coolpacks.

11. A method as claimed in claim 1, comprising creating a third refinement region corresponding to the water within the trough domain.

12. A method as claimed in claim 1, wherein simulating the wading event comprises resolving flow field around the second mesh representing the vehicle domain.

13. A method as claimed in claim 1, wherein simulating the wading event comprises solving multiphase flow using a volume of fluid model.

14. A method as claimed in claim 1, wherein simulating the wading event comprises solving turbulence using a shear stress transport model.

15. A method as claimed in claim 1, comprising calculating transient pressures at one or more locations on the vehicle domain.

16. A method as claimed in claim 1, wherein motion of the second mesh through the first mesh comprises a combination of rotation and translation motion.

17. A method as claimed in claim 16, comprising defining coordinate systems at front and rear axles of vehicle.

18. A method as claimed in claim 17, comprising maintaining the coordinate systems parallel with the ground of the trough domain.

19. A method as claimed in claim 1, wherein the second mesh comprises one or more sub meshes each comprising a vehicle wheel and wherein said sub meshes are rotatable about an axis of rotation corresponding to a vehicle axle.

20. A method according to claim 19 comprising rotating said one or more sub meshes during said simulation.

21. A system for performing a computer implemented analysis of a vehicle in a simulated wading event, the system comprising:
an input arranged to receive data relating to a vehicle and a trough region to be waded by the vehicle;
a processor arranged to:
define a trough domain representing the trough region comprising a water level to be waded by the vehicle;
define a vehicle domain comprising a simulation of the vehicle;
generate a first mesh comprising a plurality of finite mesh elements representing the trough domain;
generate a second mesh comprising a plurality of finite mesh elements representing the vehicle domain;
define an overset between the first and second meshes;
simulate the wading event by moving the second mesh representing the vehicle domain through the first mesh representing the trough domain,
resolve the forces on at least a subset of the finite mesh elements to obtain transient pressures on at least a part of said vehicle domain, and
an output arranged to output data indicative of said transient pressures.

22. A method of assessing the performance of a functional part of a vehicle during a wading event, the method comprising
modeling the surface of the vehicle, the model comprising the functional part to be tested;
simulating the wading event by;
defining a trough domain representing a region comprising a water level to be waded by the vehicle;
defining a vehicle domain comprising a simulation of the vehicle;
generating a first mesh comprising a plurality of finite mesh elements representing the trough domain;
generating a second mesh comprising a plurality of finite mesh elements representing the vehicle domain;
defining an overset between the first and second meshes;
simulating the wading event by moving the second mesh representing the vehicle domain through the first mesh representing the trough domain,
resolving the forces on at least a subset of the finite mesh elements to obtain transient pressures on at least a part of said vehicle domain,
obtaining transient pressure data from the simulation of the wading vehicle;
modeling the effects of the transient pressure data on the functional part;
determining loading data on the functional part from the transient pressure modeling; and
assessing the performance of the functional part from the determined loading data.

23. A method as claimed in claim 22, wherein assessing the performance of the functional part comprises comparing the performance of the assessed functional part with previously assessed functional part designs.

24. A method as claimed in claim 22, wherein assessing the performance of the functional part comprises comparing the determined loading data with physical testing data.

25. A method as claimed in claim 22, wherein modeling the surface of the vehicle comprises stitching gaps in the surface of the vehicle to create a water tight assembly.

26. A system for assessing the performance of a functional part of a vehicle during a wading event, the system comprising
an input arranged to receive data relating to a vehicle and a trough region to be waded by the vehicle
a processor arranged to:
model the surface of the vehicle, the model comprising the functional part to be tested;
define a trough domain representing the trough region comprising a water level to be waded by the vehicle;
define a vehicle domain comprising a simulation of the vehicle;
generate a first mesh comprising a plurality of finite mesh elements representing the trough domain;
generate a second mesh comprising a plurality of finite mesh elements representing the vehicle domain;
define an overset between the first and second meshes;
simulate the wading event by moving the second mesh representing the vehicle domain through the first mesh representing the trough domain,
resolve the forces on at least a subset of the finite mesh elements to obtain transient pressures on at least a part of said vehicle domain;
obtain transient pressure data from the simulation of the wading vehicle;
model the effects of the transient pressure data on the functional part;
determine loading data on the functional part from the transient pressure modeling; and
assess the performance of the functional part from the determined loading data an output arranged to output a performance indication for the functional part.

27. A computer program product comprising computer readable code for controlling a computing device to carry out a method of performing a computer implemented analysis of a vehicle in a simulated wading event, the method comprising:
defining a trough domain representing a region comprising a water level to be waded by the vehicle;
defining a vehicle domain comprising a simulation of the vehicle;
the method further comprising:
generating a first mesh comprising a plurality of finite mesh elements representing the trough domain;
generating a second mesh comprising a plurality of finite mesh elements representing the vehicle domain;
defining an overset between the first and second meshes;
simulating the wading event by moving the second mesh representing the vehicle domain through the first mesh representing the trough domain,
resolving the forces on at least a subset of the finite mesh elements to obtain transient pressures on at least a part of said vehicle domain, and
outputting data indicative of said transient pressures.
